(19) United States
(12) Patent Application Publication
(10) Pub. No.: US 2014/0201708 A1
(43) Pub. Date: Jul. 17, 2014

(54) Integrated Development Environment support for JavaScript™ software code that uses an object literal to define meta data and system code.

(71) Applicant: Martin Carl Euerle, Robbinsdale, MN (US)

(72) Inventor: Martin Carl Euerle, Robbinsdale, MN (US)

(21) Appl. No.: 13/741,912

(22) Filed: Jan. 15, 2013

(51) Int. Cl. G06F 9/44

(52) U.S. Cl. CPC G06F 8/311
USPC 717/106

(57) ABSTRACT

This invention is a method to provide Integrated Development Environment (IDE) support where a JavaScript object literal is used to define meta data and system code and where the meta data identifies external resources and their functions.

### BACKGROUND OF INVENTION

This method provides the capability of using a JavaScript literal acting as meta data for a resource function that is, in turn, used to define a class at runtime, which is used to create new instances of class Objects. There currently is no accurate IDE support to provide code completion for this design pattern since name spacing is a separate activity from the software code implementation.

### DETAILED DESCRIPTION

The invention can be implemented in numerous ways: as an application, as a process, as a system, or as a computer network where instructions are sent over communication links. The general order of the process may be altered within the scope of the invention. All code samples are for the demonstration of invention concepts. The code could be rendered in a variety of ways. Visual representation of code completion can also be rendered in a variety of ways.

A sample of the Resource Unit Design Pattern:
Code Sample 1:

| | |
|---|---|
| resourceUnit ( { | |
| name_s | : “os.dir.Person”, |
| version_s | : “1.0.0”, |
| extends_s | : “os.lang.Object”, |
| required_ary | : [ |
| | { name_s : “os.lang.Object”, version _s : “1.0.0” } |
| | ] |
| resource_fn | : function (Resource) { |

```
    // Resource Class
    var Person = function (firstName_s_p, lastName_s_p) {
      this._firstName_s_c = firstName_s_p;
      this._lastName_s_c = lastName_s_p;
    }
    Person.prototype.getFirstName = function( ) {
      return (this._firstName_s_c) ;
    }
    Person.prototype.getLastName = function( ) {
      return (this._lastName_s_c) ;
    }
    return (Person) ;
  }
} );
```

For this example the properties are: name_s, version_s, extends_s, required_ary, and resource_fn. The property resource_fn is the “Resource Function” function. It contains the class Person, which is the “Resource Class.” The “Resource” object contains references to the identified properties. Calling Resource.getNew(“os.lang.Object”) would return a new instance of os.lang.Object that is of the identified version, in this case 1.0.0.
Code Sample 2:

| | |
|---|---|
| resourceUnit ( { | |
| name_s | : “os.dir.Student”, |
| version_s | : “1.0.0”, |
| extends_s | : “os.dir.Person”, |
| required_ary | : [ |
| | { name_s : “os.dir.Person”, version_s : “1.0.0” } |
| | ] |
| resource_fn | : function (Resource) { |
| var Student | = function (firstName_s_p, lastName_s_p, studentId_s_p) { |

```
      this._studentId_s_c = studentId_s_p;
    }
    Student.prototype.getStudentId = function( ) {
      return(this._studentId_s_c) ;
    }
    return (Student);
  }
} );
```

Code Sample 3:

os.define ( {

| | |
|---|---|
| name_s | : “os.dir.TestStudent”, |
| version_s | : “1.0.0”, |
| extends_s | : “os.lang.Object”, |
| required_ary | : [ |
| | { name_s : “os.lang.Object”, version_s : |
| | “1.0.0” }, |
| | { name_s : “os.dir.Person”, version_s : |
| | “1.0.0” }, |
| | { name_s : “os.dir.Student”, version_s : |
| | “1.0.0” } |
| | ] |
| resource_fn | : function(Resource) { |

```
    var TestStudent = function( ) {
    }
    TestStudent.prototype.testGetStudentId = function( ) {
```

| | |
|---|---|
| var person_m | = Resource.getNew (“os.dir.Person”, “John”, |
| | “Doe”) ; |
| var student_m | = Resource.getNew (“os.dir.Student”, “John”, |
| | “Doe”, “54321”) ; |
| var first Name_s_m | = person_m.getFirstName( ) ; |

```
    }
    return (TestStudent);
  }
} );
```

The IDE will show the available resources when referring to a new class as in Code Sample 3:

TestStudent.prototype.testGetStudentId = function( ) {

| | |
|---|---|
| var person_m | = Resource.getNew (“os.dir.Person”, “John”, “Doe”) ; |
| var student_m | = Resource.getNew (“os.dir.Student”, |
| | “John”, “Doe”, “54321”) ; |
| var firstName_s_m | = person_m.getFirstName( ) ; |

}

The IDE will provide visual code completion when accessing a new class:
Typing:

var person_m=Resource.getNew(
Will cause code completion to show:

| | |
|---|---|
| var person_m = Resource.getNew ( | |
| | “os.lang.Object” |
| | “os.dir.Person” |
| | “os.dir.Student” |

Then, the user is able to select one of the required resources that is provided in the Resource Unit property required_ary.

Similarly, code completion will be available for any other Resource Reference function that refers to an available resource.

Next, the IDE shows available functions to defined classes when referring to a variable that has been declared to be of a particular type derived from a Resource function.

Using the following example:

TestStudent.prototype.testGetStudentId = function ( ) {

| | |
|---|---|
| var person_m | = Resource.getNew (“os.dir.Person”, “John”, “Doe”) ; |
| var student_m | = Resource.getNew (“os.dir.Student”, “John”, |
| | “Doe”, “54321”) ; |
| var firstName_s_m | = person_m.getFirstName ( ) ; |

}

When the user types:

var firstName_s_{—m=person}_m.

All available functions and variables will be listed for code completion:

| | | |
|---|---|---|
| this._person_m. | | |
| | [ _firstName_s_c | ] |
| | [ _lastName_s_c | ] |
| | [ getFirstName | ] |
| | [ getLastName | ] |

The user is then able to select one of the displayed values.

An example of how code completion appears in NetBeans, a common development environment:

Code completion will have similar capabilities but appear differently in other development environments.

Additional code completion information may include inferred variable data type, inferred return data type information, inherited variables, inherited functions and interface functions.

Additional functions that refer to meta data references may also be used:
resourceReference.getInstance: refers to a singleton instance of a class.
resourceReference.getClass: refer to returning a named class as a function as opposed to returning a new Object derived from a named class.

1. Integrated Development Environment support for JavaScript (™) software code that uses an Object literal to define meta data and system code and where the meta data identifies external resources and their functions.

2. A method as recited in claim 1, wherein the software code uses a programming language.

3. A method as recited in claim 2, wherein the programming language is a prototype-based language.

4. A method as recited in claim 2, wherein the programming language is a script language.

5. A method as recited in claim 2, wherein the programming language is JavaScript ™.

6. A method as recited in claim 1, wherein an Object literal that defines meta data and system code is hereinafter referred to as a “Resource Unit.”

7. A method as recited in claim 6, wherein the Resource Unit contains a set of properties.

8. A method as recited in claim 7, wherein one of the properties of the Resource Unit is a function containing software code, hereinafter referred to as a “Resource Function.”

9. A method as recited in claim 8, wherein the Resource Function contains a class, hereinafter referred to as a “Resource Class.”

10. A method as recited in claim 6, wherein the Resource Unit contains properties that are meta data accessible to the Resource Function.

11. A method as recited in claim 1, wherein the software code contains a variable that is defined, hereinafter referred to as a “Resource”, that is passed to the Resource Function and that is usable by the Resource Class. The Resource is a class that has functions that refer to properties identified in the Resource Unit.

12. A method as recited in claim 1, wherein an Integrated Development Environment relates the meta data properties of the Resource Unit with the Resource Function and Resource Class via a Resource Object.

13. A method as recited in claim 1, wherein Objects created using the Resource Object will support code completion for the referred objects' functions.
